(19) United States
(12) Patent Application Publication
(10) Pub. No.: US 2007/0185985 A1
(43) Pub. Date: Aug. 9, 2007

(54) Method for requesting triggered location service between terminals in location information system

(75) Inventors: Dong-Hee Shim, Seoul (KR); Jae-Hyuk Choi, Gyeonggi-Do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/657,445

(22) Filed: Jan. 25, 2007

Related U.S. Application Data
(60) Provisional application No. 60/762,123, filed on Jan. 26, 2006.
(60) Provisional application No. 60/795,201, filed on Apr. 27, 2006.

(30) Foreign Application Priority Data
Jan. 11, 2007 (KR) 10-2007-0003498

(51) Int. Cl. G06F 15/173

(52) U.S. Cl. 709/223

(57) ABSTRACT

Disclosed is a method for requesting a triggered location service between terminals in an SUPL-based location information system, and more particularly, a method for requesting a triggered location service related to an area event. When a triggered service of a second terminal is requested in a certain area from a first terminal, a network of the first terminal transfers the triggered service request to a second network of the second terminal. The second network initiates a positioning session with the second terminal, exchanges positioning messages and calculates a location of the second terminal, then compares the calculated location with a certain area set by the first terminal, and notifies area event occurrence in the certain area to the first terminal.

### BACKGROUND OF THE INVENTION

1. Field of the Invention

The present invention relates to a location information system based upon a Secure User Plane Location (SUPL) architecture, and more particularly, to a method for requesting a triggered location service between two terminals.

2. Description of the Related Art

A mobile communication system provides a location service for supplying a location of a terminal to a certain entity periodically or in response to a request, by including a relevant functional part for calculating the location of the terminal in a mobile communication network.

The location service-related network structure varies according to the internal network structure such as 3GPP or 3GPP2. Methods for calculating a current location of a terminal include a cell-ID method for transferring an ID of a cell to which the terminal belongs, a method for measuring the time taken for radio waves of the terminal to reach each base station and calculating the location of the terminal by using trigonometric measurement, and a method using the Global Positioning System (GPS).

In order to provide the location service to a user, considerable signaling and location information should be transferred between the terminal and a location server. The so-called ‘positioning technologies’ that have been standardized for providing such location services, for instance, a location service based upon the location (position) of a mobile terminal, are undergoing rapid widespread dissemination. The positioning technologies can be provided through a user plane and a control plane. A Secure User Plane Location (SUPL) protocol, which is well-known as an example of the positioning technologies, provides the location service through the user plane.

The SUPL protocol is an efficient method for transferring the location information required for the location calculation of a mobile station. The SUPL protocol employs a user plane data bearer so as to transfer positioning assistance information such as GPS assistance, and to carry positioning technology associated protocols between the mobile terminal and a network.

In general, an SUPL network for providing the location service in a location information system includes an SUPL agent, SUPL Location Plafform (SLP), and SUPL Enabled Terminal (SET). The SUPL agent refers to a logical service access point using location information which is actually measured. The SLP refers to a SUPL service access point at a network portion where network resources are accessed to obtain the location information. The SET, being a device capable of communicating with the SUPL network using a SUPL interface, may be one of a User Equipment (UE) for UMTS, a Mobile Station (MS) for GSM, an IS-95 MS, a laptop computer having a SET function, a Personal Digital Assistant (PDA) or the like. The SET can be various mobile terminals which are connected through a Wideband LAN (WLAN). The SET supports various procedures defined by the SUPL protocol by being connected to the network through the user plane bearer.

In a mobile communication system such as the location information system, a network for which a user has initially registered is called a home network, and when the user moves or roams to another area, other than the home network area, the network of that other area is called a visited network. An SLP in the home network is called an H-SLP while an SLP in the visited network is called a V-SLP. When an SUPL procedure starts in the network, an SLP to which an external client is first connected is called an R-SLP (requesting SLP). The R-SLP is a logical entity, which can be the same as the H-SLP or not. An SET aimed to track its current location is defined by a target SET.

The SLP, as a location server in the network, may include an SUPL Positioning Center (SPC) which is an entity for calculating an actual location and an SUPL Location Center (SLC) for managing other functions of the SLP excluding the function for calculating location information, for instance, roaming, resource managing, and the like. Therefore, the SET can calculate the location information by communicating with the SPC via the SLC (Proxy mode), or calculate the location information by opening a direct connection with the SPC (Non-proxy mode).

However, a triggered location service based upon the related art SUPL cannot provide a method for requesting the triggered location service for a desired counterpart using a user's terminal.

Further, an area event-related triggered location service based upon the related art SUPL cannot provide a method for requesting a triggered location service by defining an area related to the location of the terminal.

### SUMMARY OF THE INVENTION

Therefore, an object of the present invention is to provide a method for requesting a triggered location service of a desired counterpart using a user's terminal.

Another object of the present invention is to provide a method for requesting a triggered location service by defining an area related to a location of a terminal.

To achieve these and other advantages and in accordance with the purpose of the present invention, as embodied and broadly described herein, there is provided a method for requesting a triggered location service between terminals in a location information system, the method comprising: requesting, by a first terminal, a triggered service of a second terminal in a certain area; transferring the triggered service request to a second network of the second terminal from a first network of the first terminal; initiating, by the second network, a positioning session with the second terminal and calculating a location of the second terminal by exchanging positioning messages; and comparing, by the second network, the calculated location with the certain area set by the first terminal and notifying an area event occurrence in the certain area to the first terminal.

Preferably, the first and the second networks refer to location servers, and the first and the second terminals refer to SUPL Enabled Terminals (SETs).

Preferably, the triggered service is requested through a session start message.

Preferably, the session start message includes a session-id, SET capabilities, location identifier, msid, request type, defined area, and event type.

Preferably, the request type indicates that a service request is a triggered service related to a certain location.

Preferably, the defined area indicates a specific area, and the event type indicates which area event is desired. Herein, the defined area includes coordinates or area names.

Preferably, the triggered service request is transferred from the first network to the second network through an RLP message.

Preferably, the method further comprises: notifying, by the second network, the initiation of the triggered session to the first network through an RLP message when the positioning session with the second terminal is initiated; and transmitting, by the first network, a session end message to the first terminal and ending a connection between the first terminal and the first network.

To achieve these and other advantages and in accordance with the purpose of the present invention, a method for requesting a triggered location service between terminals in a location information system according to another embodiment comprises: requesting, by a first terminal, a triggered service of a second terminal to a first location server; transferring the triggered service request from the first location server to a second location server; initiating, by the second location server, a positioning session with the second terminal and calculating a location of the second terminal; and providing, by the second location server, a periodic positioning service or area-related positioning service through the first location server according to a triggered service request type of the first terminal.

Preferably, the triggered service is requested through an SET init message.

Preferably, the SET init message includes a session-id, target SETid, triggered mode, and trigger information.

Preferably, the triggered mode indicates an SET initiated trigger service of another SET type and includes periodic event or area event parameters.

Preferably, the trigger information refers to trigger session parameters and includes periodic parameters and area event parameters.

Preferably, the periodic parameters include periodic information, and the area event parameters include defined area and event type.

Preferably, the first location server uses an identity of the second terminal included in the SET init message to determine a second location server.

Preferably, the second location server analyzes the triggered service request of the first terminal, and if it is determined that the first terminal requested a periodic triggered service, then reports a location of the second terminal through the first location server to the first terminal each period.

Preferably, if it is determined that the first terminal requested an area event triggered service, the second location server compares the calculated location with a certain area set by the first terminal to notify an area event occurrence in the certain area to the first terminal.

To achieve these and other advantages and in accordance with the purpose of the present invention, a method for requesting a triggered location service between terminals in a location information system according to a further embodiment comprises: requesting, by a first terminal, positioning of a second terminal to a first location server through an SET init message; transferring the positioning request of the second terminal to a second location server through a location request message by the first location server; performing, by the second location server, positioning procedure periodically with the second terminal and calculating the location of the second terminal; and receiving, by the first location server, the location values of the second terminal calculated in the second location server through each location response message and reporting said location values of the second terminal to the first terminal.

Preferably, the first location server uses an identity of the second terminal included in the SET init message to determine the second location server.

Preferably, the first and the second location servers exist in home networks of the first and the second terminals, respectively, and refer to an SUPL Location Platform (SLP).

Preferably, the SET init message includes a session-id, id of the second terminal, triggered mode, and trigger information.

Preferably, the triggered mode indicates an SET-initiated trigger service of another SET type, and includes periodic event or area event parameters.

Preferably, the trigger information refers to trigger session parameters, and includes periodic parameters and area event parameters.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a first embodiment of the method for requesting a triggered location service between terminals in a location information system according to the present invention;

FIG. 2 illustrates a second embodiment of the method for requesting a triggered location service between terminals in a location information system according to the present invention;

FIG. 3 illustrates a third embodiment of the method for requesting a triggered location service between terminals in a location information system according to the present invention;

FIG. 4 illustrates a fourth embodiment of the method for requesting a triggered location service between terminals in a location information system according to the present invention;

FIG. 5 illustrates a fifth embodiment of the method for requesting a triggered location service between terminals in a location information system according to the present invention;

FIG. 6 illustrates a sixth embodiment of the method for requesting a triggered location service between terminals in a location information system according to the present invention;

FIG. 7 illustrates a case that a location-related request is an area event in accordance with a seventh embodiment of the method for requesting a triggered location service between terminals in a location information system of the present invention; and

FIG. 8 illustrates a case of a periodic location-related request in accordance with an eighth embodiment of the method for requesting a triggered location service between terminals in a location information system of the present invention.

### DETAILED DESCRIPTION OF THE INVENTION

The present invention is typically implemented in the SUPL network. However, the present invention may be applied to a wireless communications system operated according to a different specification. Reference will now be made in detail to the preferred embodiments of the present invention, examples of which are illustrated in the accompanying drawings.

The present invention provides a method for requesting an area event-related triggered location service of a desired counterpart using a user's terminal in an SUPL-based location information system. To this end, when requesting the area event-related triggered location service, the user can designate an area for the area event as a certain area, which is related to a current location of his terminal, or as a specific area, which is not related to the location of his terminal.

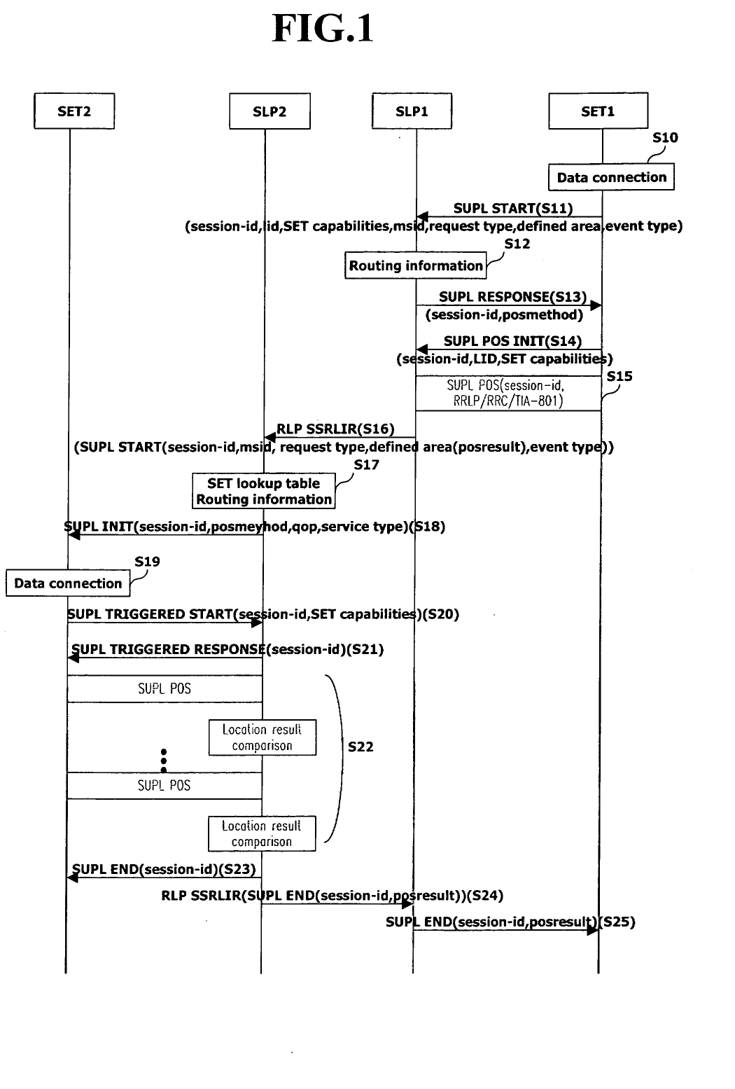

FIG. 1 illustrates a first embodiment of the method for requesting a triggered location service between terminals in a location information system according to the present invention. In particular, the first embodiment represents a method for checking an area event of SET2 in the certain area which is related to a current location of SET1 requesting a service. Here, the SLP corresponds to a network side and the SET corresponds to a terminal side.

Referring to FIG. 1, an SUPL agent in SET1 receives a location-related request from an application which is being operated in SET1.

When the location-related request is received, in case a data connection is currently not established to any network SET1 is connected to a packet data network (S10).

If the data connection is established, SET1 establishes a secure IP connection with a location server (SLP1) using a default address provided by the network, and transmits a session start message (SUPL START message) to start a location-measuring (positioning) session with SLP1 (S11). The SUPL START message includes a session-id, SET capabilities, location identifier (lid), msid, request type, defined area, event type, and the like. Here, the request type indicates that the service request is a triggered service related to the location of SET1. The defined area indicates how wide an area is defined from the location of SET1. The event type indicates a type of an area event (whether it is moving out, moving in, or existing). And, the SET capabilities include positioning methods that can be supported (e.g., SET-Assisted A-GPS and SET Based A-GPS) and associated positioning protocols (e.g., RRLP, RRC, and TIA-801). And, if a previously calculated location satisfies the quality of position (QoP) requested by SET1, SLP1 proceeds to the next step (S16).

If the previously calculated location does not satisfy the requested QoP, SLP1 confirms that SET1 is not roaming (it currently belongs to a service region) using routing information (S12), and determines SLP2, which is a location server related to SET2, on the basis of the received msid.

Thereafter, SLP1 determines an appropriate positioning method so as to maintain consistency with the positioning method supported by the SET capabilities of SET1 which is included in the SUPL START message. If required in the determined positioning method, SLP1 uses the supported positioning protocols (i.e., RRLP, RRC, and TIA-801) which are included in the SUPL START message. After these series of operations are completed, SLP1 transmits a session response message (SUPL RESPONSE message) including the determined positioning method to SET1 (S13). The SUPL RESPONSE message includes a session-id, but does not include the address of SLP1 since SET1 does not need to establish a new connection.

Also, if information included in the SUPL START message, e.g., a coarse location result calculated by the lid, satisfies the QoP requested by SET1, SLP1 immediately proceeds to the next step (S16).

In response to the receipt of the SUPL RESPONSE message, SET1 then transmits a positioning session initiation message (SUPL POS INIT message) to SLP1 (S14). The SUPL POS INIT message includes at least a session-id, SET capabilities, and location identifier (lid).

When the SUPL POS INIT message is received, SLP1 calculates the location of SET1 by sequentially exchanging positioning process messages (SUPL POS messages) with SETI (S15). In this case, the location is calculated on the basis of measurements that SLP1 has received from SET1 (SET-Assisted), or assistance data that SET1 has obtained from SLP1 (SET-Based).

When the SUPL positioning process between SLP1 and SET1 is completed, SLP1 requests a triggered service to SLP2, as the location server of SET2, using an RLP protocol message (RLP SSRLIR message) (S16). The RLP RRSLIR message includes a session-id, msid, request type, defined area, and event type. The request type indicates that the service request is a triggered service related to the location of SET1. The defined area indicates the calculated location of SET1 and how wide an area is defined from the location of SET1. The event type indicates which area event (moving out, moving in, and existing) is desired. And, if SLP2 has authority over the triggered service requested by SET1, SLP2 authorizes SET1 using a received client-id and applies subscriber privacy using a received msid against SET1.

When the RLP SSRLIR message is received, SLP2 checks whether SET2 supports the SUPL using a SET look-up table, and checks whether SET2 currently belongs to a service region (whether SET2 is roaming) using routing information (S17).

According to the checked result, when SET2 supports the SUPL and is not roaming, SLP2 initiates a location session with SET2 using a session initiation message (SUPL INIT message). The SUPL INIT message includes at least a session-id, proxy/non-proxy mode indicator, positioning method (posmethod) to be used, and a service type indicating an area event triggered service. In addition, the SUPL INIT message may include a desired QoP.

When the SUPL INIT message is received, SET2 is connected to a packet data network if a data connection to any network is currently not already established (S19). SET2 then transmits a session triggered start message (SUPL TRIGGERED START message) to start a positioning session with SLP2 (S20). The SUPL TRIGGERED START message includes at least a session-id, SET capabilities, and location identifier (lid).

If a coarse positioning result calculated by information (e.g., lid) included in the received SUPL TRIGGERED START message satisfies a QoP requested by SET2, SLP2 compares the coarse positioning result with a designated location event received from SLP1 (S22).

Conversely, if the calculated coarse positioning result does not satisfy the QoP requested by SET2, SLP2 transmits a SUPL TRIGGERED RESPONSE message to SET2 to notify the initiation of a triggered session. The SUPL TRIGGERED RESPONSE message includes a positioning method to be used in the triggered session.

Thereafter, positioning sessions are periodically generated between SET2 and SLP2 (S22). When each positioning session starts, positioning process messages (SUPL POS messages) are successfully exchanged between SET2 and SLP2. In this case, the location is calculated on the basis of measurements that SLP2 has received from SET2 (SET-Assisted), or assistance data that SET2 has obtained from SLP2 (SET-Based). After each positioning session is completed, SLP2 compares the calculated location of SET2 with the designated location received from SLP1. According to the comparison, if the calculated location of SET2 corresponds to the defined area which is set by SET1 and is a location value received via SLP1, SLP2 proceeds to the next step, and if not, SLP2 repeats the step (S22).

If the calculated location of SET2 corresponds to the defined area which is set by SET1 and is the location received through SLP1, SLP2 terminates the positioning session by transmitting a session end message (SUPL END message) to SET2 (S23), and then transmits an RLP SSRLIR message including a positioning comparison resultant value (POSRESULT) of SET2 to SLP1 (S24).

Therefore, SLP1 transmits a SUPL END message including the positioning comparison resultant value (POSRESULT) of SET2 to SET1 (S25), whereupon SET1 releases the secure IP connection with SLP1 and releases all resources associated with that session.

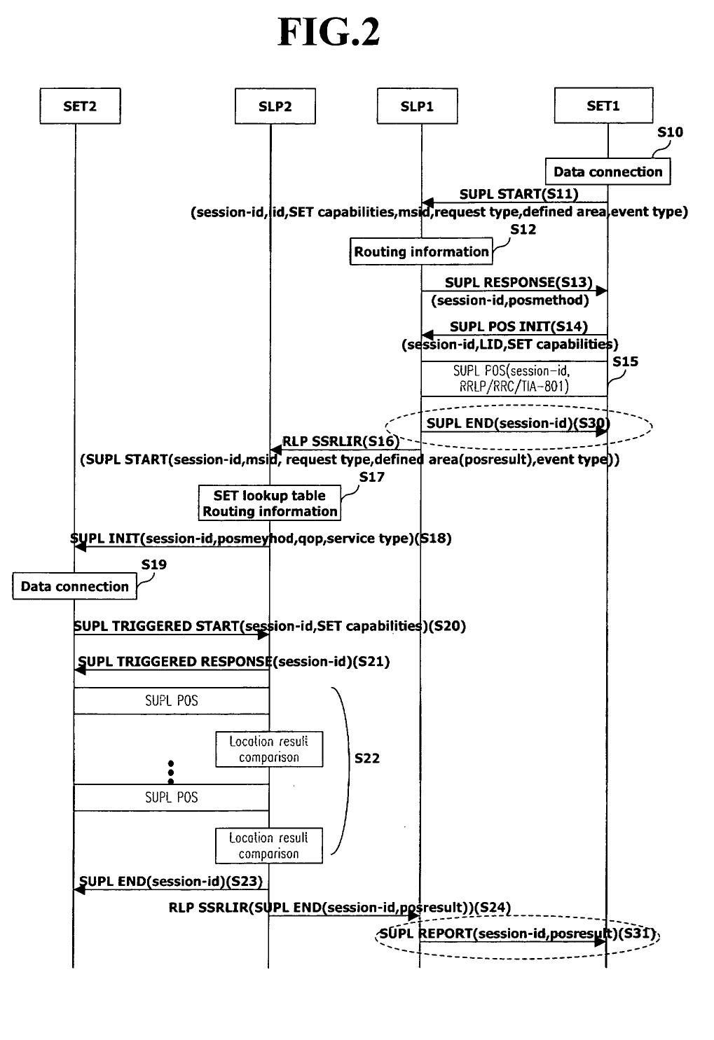

FIG. 2 illustrates a second embodiment of the method for requesting a triggered location service between terminals in a location information system according to the present invention. The second embodiment of the present invention is similar to the first embodiment, except that before transmitting the RLP message to SLP2, connection between SLP1 and SET1 is terminated. That is, in the first embodiment, the IP connection between SET1 and SLP1 is maintained until the final step (S25) is performed, thus to cause unnecessary waste of the radio resources. Therefore, the second embodiment of the present invention terminates the IP connection between SET1 and SLP1 by transmitting the SUPL END message from SLP1 to SET1 immediately after the completion of the positioning process between SLP1 and SET1.

Accordingly, when the positioning process between SET1 and SLP1 is completed, SLP1 transmits the SUPL END message containing session id to SET1 to end the connection between SET1 and SLP1 (S30), and SLP1 then requests a triggered service to SLP2, which is the location server of SET2, by using an RLP protocol message (RLP SSRLIR message). The following steps (S16˜S24) are the same as in the first embodiment and thus detailed explanations therefor are omitted.

When a desired triggered result (POSRESULT) of SET2 is received from SLP2 (S24), SLP1 transmits the given triggered result to SET1, via a SUPL report message (SUPL REPORT message) (S31). The SUPL REPORT message is transmitted via WAP PUSH, SMS trigger, and the like.

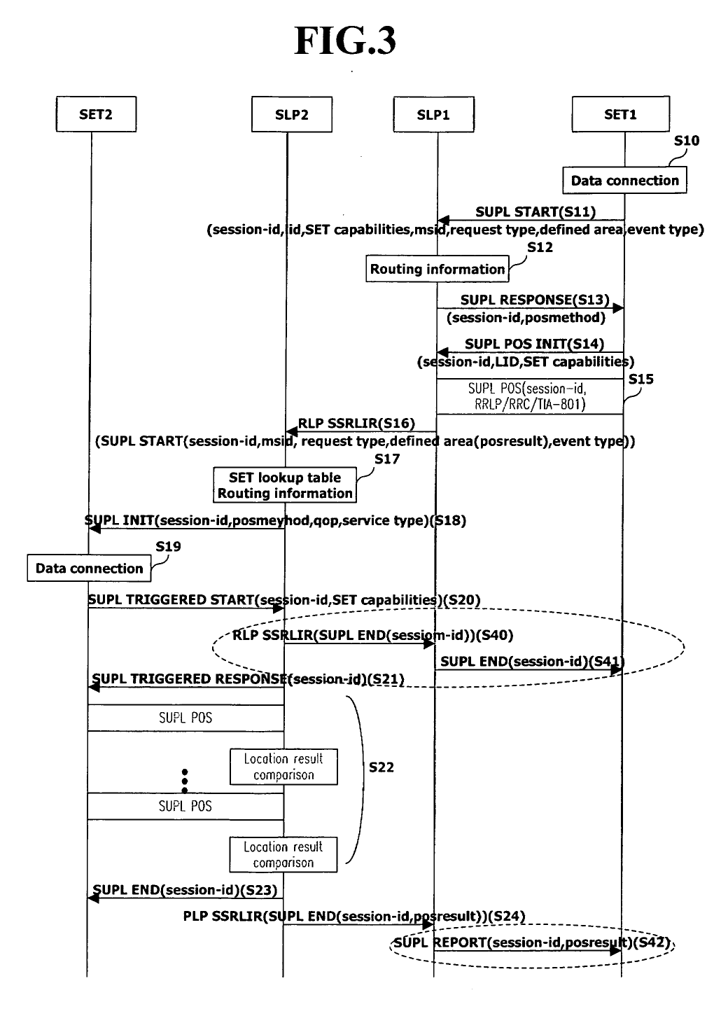

FIG. 3 illustrates a third embodiment of the method for requesting a triggered location service between terminals in a location information system according to the present invention. The third embodiment is similar to the second embodiment in that the SUPL END message is transmitted to terminate the IP connection between SET1 and SLP1. However, they differ in when the SUPL END message is transmitted.

That is, in the second embodiment of the present invention, the SUPL END message is transmitted immediately after the positioning procedure between SLP1 and SET1 is completed. In the third embodiment of the present invention, the SUPL END message is transmitted only after SLP2 confirms that a positioning session between SLP2 and SET2 will start. The confirmation is possible when SLP2 receives an SUPL TRIGGERED START message from SET2 and transmits an RLP SSRLIR END message to SLP1.

Accordingly, when the SUPL TRIGGERED START message is received from SET2 and after the RLP SSRLIR END message is transmitted to SLP1 (S40), SLP2 transmits the SUPL TRIGGERED RESPONSE message to SET2, to notify the initiation of the triggered session (S41). For all other steps (S21-S24), which are the same as those in the second embodiment, detailed explanations therefor are omitted.

Upon receiving the RLP SSRLIR END message, SLP1 transmits the SUPL END message to SET1 to terminate the connection between SET1 and SLP1 (S41). Thereafter, when a desired triggered result of SET2 (POSRESULT) from SLP2 is received (S24), SLP1 transmits the given triggered result to SET1 via an SUPL REPORT message (S42). The SULP REPORT message is transmitted via WAP PUSH, SMS trigger, and the like.

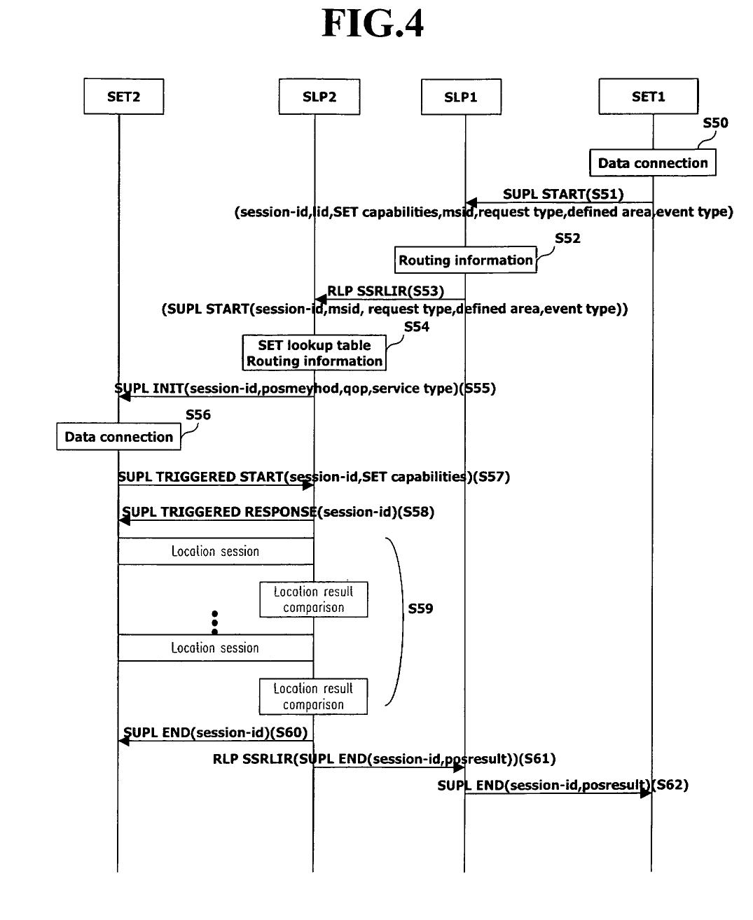

FIG. 4 illustrates a fourth embodiment of the method for requesting a triggered location service between terminals in a location information system according to the present invention. In particular, the fourth embodiment is a method for checking an area event of SET2 in a specific region which is set by SET1, and the method does not perform a positioning procedure between SET1 and SLP1.

Referring to FIG. 4, an SUPL agent in SET1 receives a location-related request from an application which is being operated in SET1. When the location-related request is received, SET1 is connected to a packet data network in case a data connection is currently not already established to any network (S50).

Once the data connection is established, SET1 establishes a secure IP connection with a location server (SLP1) using a default address provided by the network, and transmits an SUPL START message to start a location-measuring (positioning) session with SLP1 (S51). The SUPL START message indudes a session-id, SET capabilities, location identifier (lid), msid, request type, defined area, event type, and the like. Here, the request type indicates that the service request is a triggered service related to a specific location. The defined area indicates a specific area. The event type indicates which area event (moving out, moving in, or existing) is desired by SET1. Preferably, the defined area includes i.e., coordinates or area names.

In addition, the SET capabilities include positioning methods that can be supported (e.g., SET-Assisted A-GPS and SET Based A-GPS) and associated positioning protocols (e.g., RRLP, RRC, and TIA-801).

When the SUPL START message is received, SLP1 confirms that SET1 is not roaming (it currently belongs to a service region) using routing information (S52), and determines a location server (SLP2) related to the target SET2, on the basis of the received msid.

SLP1 requests the triggered service to SLP2, which is the location server of SET2, using an RLP protocol message (RLP SSRLIR message) (S53). The RLP SSRLIR message includes a session-id, msid, request type, defined area, and event type. The request type indicates that the service request is a triggered service related to a specific location. The defined area indicates a specific area. The event type indicates which area event (moving out, moving in, or existing) is desired by SET1. If SLP2 has authority over the triggered service requested by SET1, SLP2 authorizes SET1 using the received client-id, and applies subscriber privacy using the received msid.

Upon receiving the RLP SSRLIR message, SLP2 checks whether SET2 supports the SUPL using the SET look-up table, and checks whether SET2 currently belongs to a service region (whether it is roaming) using routing information (S54).

According to the checked result, if SET2 supports the SUPL and is not roaming, SLP2 initiates a location session with SET2 using an SUPL INIT message (S55). The SUPL INIT message includes at least a session-id, proxy/non-proxy mode indicator, positioning methods (posmethod) to be used, and service type indicating the area event triggered service. In addition, the SUPL INIT message may include a desired QoP.

When the SUPL INIT message is received, SET2 connects to a packet data network in case a data connection is currently not already established to any network (S56). SET2 then transmits an SUPL TRIGGERED START message to start a positioning session the SLP2 (S57). The SUPL TRIGGERD START message includes at least a session-id, SET capabilities, and lid.

If a coarse positioning result calculated from information (e.g., lid) included in the received SUPL TRIGGERED START message satisfies a QoP requested by SET1, SLP2 compares the coarse positioning result with a designated location event received from SLP1 (S59).

Conversely, if the calculated coarse positioning result does not satisfy the QoP requested by the SET1, SLP2 transmits a SUPL TRIGGERED RESPONSE message to SET2 to notify the initiation of a triggered session (S58). The SUPL TRIGGERED RESPONSE message includes a positioning method to be used in the triggered session.

Thereafter, positioning sessions are periodically generated between SET2 and SLP2 (S59). When each positioning session starts, the SUPL POS messages are successfully exchanged between SET2 and SLP2. In this case, the location is calculated on the basis of measurements that SLP2 has received from SET2 (SET-Assisted), or assistance data that SET2 has obtained from SLP2 (SET-Based). After each positioning session is terminated, SLP2 compares the calculated location of SET2 with a defined area, which is a location received via SLP1. According to the comparison, if the calculated location of SET2 corresponds to the defined area, SLP2 proceeds to the next step, and if not, SLP2 repeats the step (S59).

If the calculated location of the SET2 corresponds to the specific area which is designated by SET1, SLP2 terminates the positioning session by transmitting a SUPL END message to SET2 (S60), and then transmits an RLP SSRLIR message including a POSRESULT of SET2 to SLP1 (S61).

Therefore, SLP1 transmits the SUPL END message including the POSRESULT of SET2 to SET1 (S62), whereupon SET1 releases the secure IP connection with SLP1 and releases all resources associated with that session.

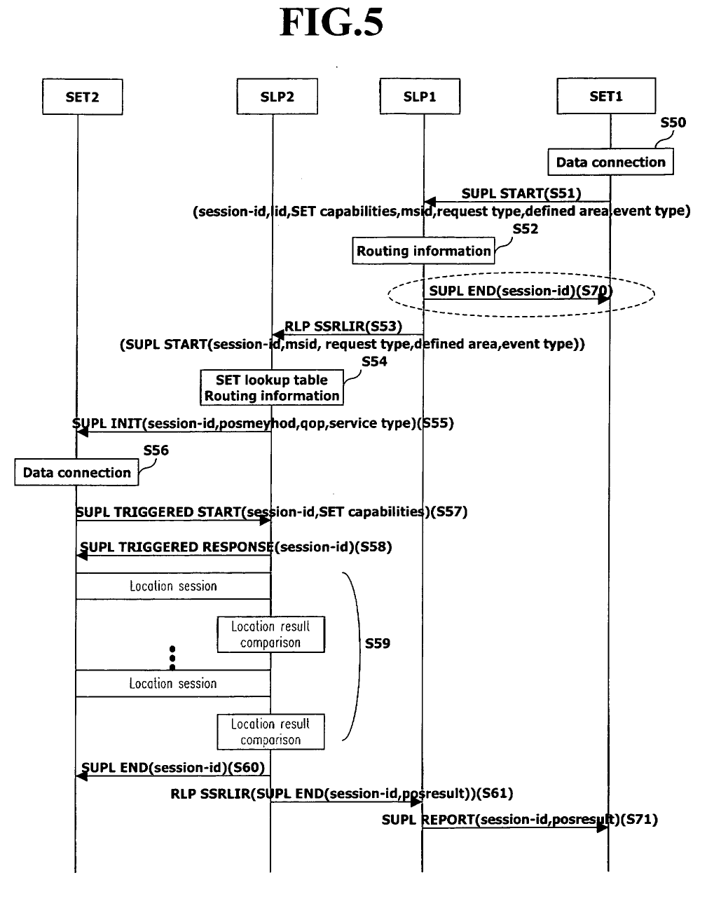

FIG. 5 illustrates a fifth embodiment of the method for requesting a triggered location service between terminals in a location information system according to the present invention. The fifth embodiment is similar to the fourth embodiment, except that the connection between SLP1 and SET1 is terminated before transmitting the RLP message to SLP2. That is, in the fourth embodiment, the IP connection between SET1 and SLP1 is maintained until the step (S62) is performed, thus to cause unnecessary waste of the radio resources.

Accordingly, in the method accordingly to the fifth embodiment as shown in FIG. 5, after SLP1 determines that SET1 is not roaming (S52) and determines the location server SLP2 of the target SET2, SLP1 transmits the SUPL END message to SET1 to thusly terminate the IP connection between SET1 and SLP1 (S70), and then requests a triggered service to SLP2, which is the location server of SET2, via the RLP SSRLIR message. The succeeding steps (S53-S61) are the same as in the fourth embodiment and thus detailed explanations therefor are omitted.

When the desired POSRESULT of SET2 is received from SLP2 (S53), SLP1 transmits the given triggered result to SET1, via a SUPL REPORT message (S71). The SUPL REPORT message is transmitted via WAP PUSH, SMS trigger, and the like.

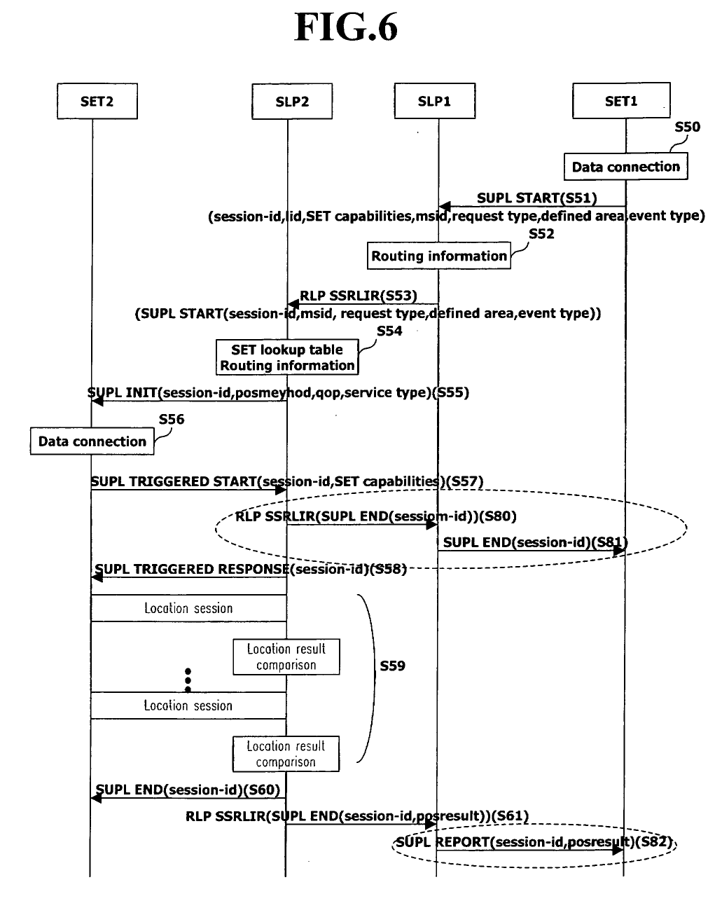

FIG. 6 illustrates a sixth embodiment of the method for requesting a triggered location service between terminals in a location information system according to the present invention. The sixth embodiment of the present invention is similar to the fifth embodiment in that the SUPL END message is transmitted to terminate the IP connection between SET1 and SLP1. However, they differ in when the SUPL END message is transferred.

That is, in the fifth embodiment of the present invention, the SUPL END message is transmitted immediately after the positioning process between SLP1 and SET1 is terminated. However, in the sixth embodiment, the SUPL END message is transmitted only after SLP2 confirms that a positioning session between SLP2 and SET will start. This confirmation is possible when SLP2 receives the SUPL TRIGGERED START message from SET2 and transmits the RLP SSRLIR END message to SLP1.

Accordingly, when the SUPL TRIGGERED START message is received from SET2 and after the RLP SSRLIR END message is transmitted to SLP1 (S80), SLP2 transmits the SUPL TRIGGERED RESPONSE message to SET2 to notify the initiation of the triggered session (S81). The steps (S58˜S61) thereafter are the same as those in the fifth embodiment, and therefore detailed explanations therefor are omitted.

Upon receiving the RLP SSRLIR END message, SLP1 transmits the SUPL END message to SET1 to terminate the connection between SET1 and SLP1 (S81). Thereafter, upon receiving the desired POSRESULT of SET2 from SLP2 (S61), SLP1 transmits the given triggered result to SET1 via the SUPL REPORT message (S82). The SULP REPORT message is transmitted via WAP PUSH, SMS trigger, and the like.

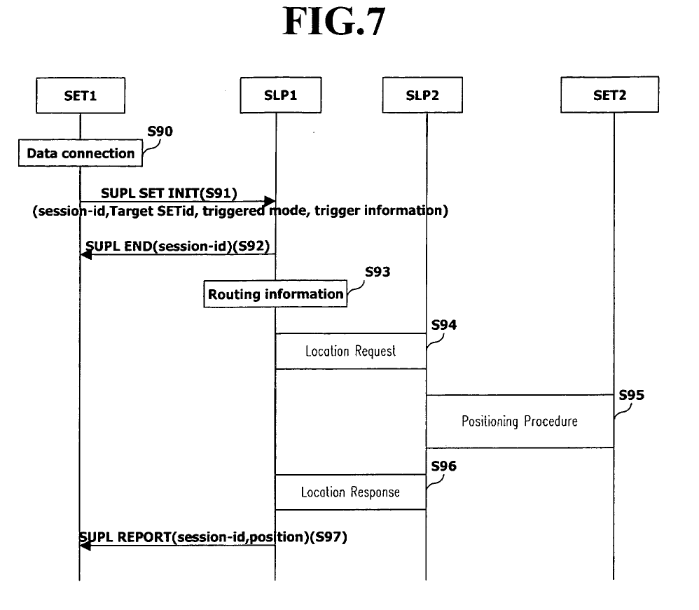

FIG. 7 illustrates a seventh embodiment of the method for requesting a triggered location service between terminals in a location information system in accordance with the present invention.

Referring to FIG. 7, a SUPL agent in SET1 receives a location-related request from an application which is being operated in SET1. Preferably, the location-related request refers to a periodic or area event request for the location of a target SET2. Here, FIG. 7 illustrates a case that the location-related request is an area event request.

When the location-related request is received, SET1 connects to a packet data network in case a data connection is currently not already established to any network (S90).

Once the data connection is established, SET1 establishes a secure IP connection with the location server (SLP1) using a default address provided by the home network, and transmits a SET initial message (SUPL SET INIT message) to SLP1 to start a positioning session of the target SET2 (S91).

The SUPL SET INIT message includes a session-id, target SETid, triggered mode, trigger information, and the like. Here, the target SETid refers to the identity of the target SET2. The triggered mode refers to a SET initiated trigger service of another SET type, and includes periodic event or area event parameters. The triggered service mode is used the same as the request type shown in FIGS. 1 through 6. The trigger information refers to trigger session parameters, and includes periodic parameters and area event parameters. For example, the periodic parameters include a trigger period, and the area event parameters include defined area and event type.

SLP1 transmits the SUPL END message to SET1 to acknowledge the receipt of the triggered service request (S92). SET1 then releases the secure IP connection based on the received SUPL END message, and releases all radio resources associated with the session. In addition, SLP1 determines the location server (SLP2) of the target SET2 using the target SETid (routing information) included in the SUPL SET INIT message (S93). That is, SLP1 determines SLP2 by contacting a local DNS server or any other entity that is able to translate the SET2 address information into information that can be used to contact SLP2.

Once SLP2 is determined, SLP1 transmits a triggered location request message to the location server (SLP2) of the target SET2 (S94). The triggered location request message includes a session-id, target SETid, triggered mode, trigger information, and the like.

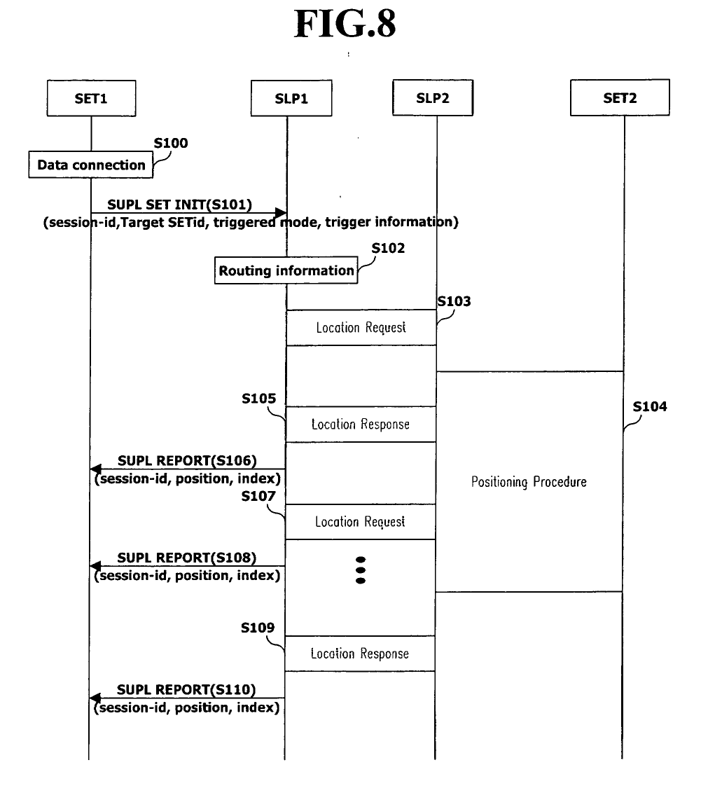

Accordingly, when the triggered location request message is received, SLP2 can use the received triggered mode and trigger information to thusly determine the triggered service type (periodic or area event) requested by SET1. Embodiments illustrated in FIG. 7 or in FIG. 8, which will be described later, are performed based on the determination.

When SLP2 has authority over a triggered service requested by SET1, SLP2 authorizes SET1 and applies subscriber privacy. If SET1 is authorized and notification and verification are requested, SLP2 transmits a network triggered location request message to SET2 and performs the network initiated positioning procedures to calculate the location of SET2 using an SUPL positioning method (S95).

However, if the previously calculated position satisfies the QoP (Quality of Position) requested by the SET1, and if notification and verification are not required, SLP2 proceeds to the next step (S96) without performing the above step (S95).

Upon completing the location calculation of SET2, SLP2 compares the calculated location with the defined area of the triggered information to thusly check whether an area event occurred in the given area. According to the checked result, if an area event occurred, SLP2 transmits a triggered location response message to SLP1 (S96), and SLP1 transmits the received position information of SET2 to SET1 using the SUPL REPORT message (S97).

FIG. 8 illustrates an eighth embodiment of the method for requesting a triggered location service between terminals in a location information system in accordance with the present invention, and shows a case of a periodic location-related request.

That is, a SUPL agent in SET1 receives a periodic event request from an application which is being operated in SET1.

After receiving the periodic location request and connecting to a packet data network (S100), SET1 establishes a secure IP connection with SLP1 using a default address provided by the home network and transmits a SUPL SET INIT message to SLP1 to start a positioning session of the target SET2 (S101).

As illustrated in FIG. 8, The SUPL SET INIT message includes a session-id, target SETid, triggered mode, trigger information, and the like. Here, the triggered mode is set to be a periodic event, and the trigger information includes periodicity parameters, i.e., triggered period.

SLP1 determines the location server (SLP2) of the target SET2 using a target SETid (routing information) included in the SUPL SET INIT message (S102).

Once SLP2 of the target SET2 is determined, SLP1 transmits a triggered location request message to SLP2 (S103). The triggered location request message includes the session-id, target SETid, triggered mode, trigger information, and the like.

SLP2 authorizes SET1 and applies subscriber privacy. If SET1 is authorized and notification and verification are requested, SLP2 transmits a network-initiated triggered location request message to SET2 and performs the network-initiated positioning procedures to calculate the location of SET2 (S104).

However, if the previously calculated position satisfies the QoP (Quality of Position) requested by SET1 and if notification and verification are not required, SLP2 proceeds to the next step (S109) without performing the above step (S95).

Therefore, based on the periodicity information included in the trigger information, SLP2 calculates the location of SET2 in each period and transmits a triggered location response message including the calculated location to SLP1 (S105 and S107). And SLP1 transmits the received location of SET2 to SET1 via the SUPL REPORT message (S106 and S108).

Thereafter, when the location calculation of SET2 is completed in the last period, in the same way, SLP2 transmits the calculated location using the triggered location response message to SLP1 (S109), and SLP1 transmits the received location of SET2 to SET1 using the SUPL REPORT message (S110). In this case, the index refers to each period.

In the present invention, the SET, being a device capable of communicating with the SUPL network, may be one of a User Equipment (UE) for UMTS, a Mobile Station (MS) for GSM, an IS-95 MS or the like. In the present invention, the SET is referred to as a terminal.

As described above, the present invention may provide more convenience to a user by requesting a triggered location service for a desired counterpart using is the user's terminal in a location information system based on the SUPL network.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for requesting a triggered location service between terminals in a location information system, comprising:
requesting, by a first terminal, a triggered location service of a second terminal in a certain area;
transferring the triggered location service request to a second network of the second terminal from a first network of the first terminal;
initiating a positioning session with the second terminal by the second network and calculating a location of the second terminal; and
comparing, by the second network, the thusly calculated location with the certain area set by the first terminal and notifying an area event occurrence in the certain area to the first terminal.

2. The method of claim 1, wherein the first and the second networks each are a location server.

3. The method of claim 1, wherein the first and the second terminals each are an SUPL Enabled Terminal (SET).

4. The method of claim 2, wherein the location server is an SUPL Location Plafform (SLP).

5. The method of claim 3, wherein the SET may be one of a User Equipment (UE) for UMTS, a Mobile Station (MS) for GSM, or an IS-95 MS.

6. The method of claim 1, wherein the triggered location service is requested through a session start message.

7. The method of claim 6, wherein the session start message includes a session-id, SET capabilities, location identifier, msid, request type, defined area, and event type.

8. The method of claim 7, wherein the request type indicates that a service request is a triggered service related to a certain location.

9. The method of claim 7, wherein the defined area indicates a specific area, and the event type indicates which area event is desired.

10. The method of claim 9, wherein the defined area includes coordinates or area names.

11. The method of claim 1, wherein the triggered location service request is transferred from the first network to the second network through an RLP message.

12. The method of claim 1, further comprising:
notifying, by the second network, the initiation of a triggered location session to the first network through an RLP message when a positioning session with the second terminal is initiated; and
transmitting, by the first network, of a session end message to the first terminal and ending a connection between the first terminal and the first network.

13. The method of claim 1, wherein the second network repeatedly performs location calculation and comparison operations of the second terminal until the calculated location corresponds to a certain area set by the first terminal.

14. The method of claim 11, wherein the first network transfers the resultant location value to the first terminal through a session report message.

15. The method of daim 14, wherein the session report message is transmitted through WAP PUSH, SMS trigger, and the like.

16. The method of claim 1, wherein the comparing and notifying step comprises:
comparing, by the second network, the calculated location with a certain area set by the first terminal; and
transmitting the resultant value to the first terminal through the first network if the calculated location corresponds to the certain area set by the first terminal.

17. A method for requesting a triggered location service between terminals in a location information system, comprising:
requesting, by a first terminal, of a triggered location service of a second terminal to a first location server;
transferring of the triggered location service request to a second location server from the first location server;
initiating, by the second location server, a positioning session with the second terminal and calculating of a location of the second terminal; and
providing, by the second location server, a periodic positioning service or area-related positioning service to the first terminal through the first location server according to a triggered location service request type of the first terminal.

18. The method of claim 17, further comprising:
determining, by the first location server, of the second location server by using an ID of the second terminal for which the triggered location service is requested.

19. The method of claim 17, wherein the first and the second location servers each are an SUPL Location Platform (SLP).

20. The method of claim 17, wherein the triggered location service is requested by a SET init message.

21. The method of claim 17, wherein the SET init message includes a session-id, target SETid, triggered mode, and trigger information.

22. The method of claim 21, wherein the trigger mode indicates a SET initiated trigger service of another SET type, and includes periodic event or area event parameters.

23. The method of claim 21, wherein the trigger information refers to trigger session parameters, and includes periodicity parameters and area event parameters.

24. The method of claim 23, wherein the periodicity parameters include periodicity information, and the area event parameters include a defined area indicating a specific region and event type indicating which area event is desired.

25. The method of claim 24, wherein the defined area includes coordinates or area names.

26. The method of claim 17, wherein the second location server analyzes a triggered location service request of the first terminal, and if it is determined that the first terminal requested a periodic triggered service, then reports a location of the second terminal through the first location server to the first terminal each period.

27. The method of claim 17, wherein the second location server analyzes a triggered location service request of the first terminal, and if it is determined that the first terminal requested an area event triggered service, the second location server compares the calculated location with a certain area set by the first terminal to notify an area event occurrence in the certain area to the first terminal.

28. A method for requesting a triggered location service between terminals in location information system, comprising:
requesting, by a first terminal, of positioning of a second terminal to a first location server through a SET init message;
transferring the positioning request of the second terminal through a location request message from the first location server to a second location server;
performing, by the second location server, of a positioning procedure with the second terminal periodically and calculating a location of the second terminal; and
receiving, by the first location server, location values of the second terminal calculated in the second location server through location response messages, and reporting said location values to the first terminal.

29. The method of claim 28, further comprising:
transferring, by the second location server, the calculated location of the second terminal to the first location server.

30. The method of claim 28, the method further comprising:
transferring, by the first location server, a session end message including the given location value to the first terminal, when the last location of the second terminal is received from the second location server.

31. The method of claim 28, further comprising:
determining, by the first location server, the second location server using an identity of the second terminal included in the SET init message.

32. The method of claim 28, wherein the first and the second location servers exist in home networks of the first and the second terminals, respectively, and are each an SUPL Location Plafform (SLP).

33. The method of claim 28, wherein the SET init message includes a session-id, id of the second terminal, triggered mode, and trigger information.

34. The method of claim 33, wherein the triggered mode indicates a SET-initiated trigger service of another SET type, and includes periodic event or area event parameters.

35. The method of claim 33, wherein the trigger information refers to trigger session parameters, and includes periodicity parameters and area event parameters.

36. The method of claim 34, wherein the periodicity parameters include periodicity information, and the area event parameters include a defined area indicating a specific area and an event type indicating which area event is desired.

37. The method of claim 35, wherein the defined area includes coordinates or area names.
